(19) United States
(12) Patent Application Publication
(10) Pub. No.: US 2005/0165866 A1
(43) Pub. Date: Jul. 28, 2005

(54) Method and apparatus for updating XML views of relational data

(76) Inventors: Philip L. Bohannon, Bridgewater, NJ (US); Xin Dong, Seattle, WA (US); Henry F. Korth, Lower Gwynedd, PA (US); Suryanarayan Perinkulam, Bridgewater, NJ (US)

Correspondence Address: Ryan, Mason & Lewis, LLP, Suite 205, 1300 Post Road, Fairfield, CT, 06824, US

(21) Appl. No.: 10/766,305

(22) Filed: Jan. 28, 2004

(51) Int. Cl. G06F 17/30

(52) U.S. Cl. 707/203

(57) ABSTRACT

A method and apparatus are provided for updating XML views of relational data. The present invention translates an update to an XML view of a relational database into update operations to be performed on the underlying relational database itself. The disclosed XML view update manager can perform updates in the context of an underlying relational database that serves the XML-based application, as well as traditional relational database management system (RDBMS) applications. Given a pre-existing underlying relational database schema and an XML view defined on it, the present invention provides a framework for generating update plans to perform an update without introducing side-effects to other parts of the view.

### FIELD OF THE INVENTION

The present invention relates generally to techniques for mapping between a relational database and an XML document, and more particularly, to a method and apparatus for updating XML publishing views of relational data.

### BACKGROUND OF THE INVENTION

As the Extensible Markup Language (XML) gains popularity as a standard for information representation and exchange, tools to render and present XML documents are increasingly supported by common application platforms. Despite widespread use of XML standards for business data exchange, the vast majority of business data is stored and maintained by relational database systems. Thus, XML-publishing middleware technology is rapidly being implemented by relational database vendors to bridge between XML applications and relational database systems by supporting XML publishing and querying. Such middleware provides a declarative view query language with which to specify the desired mapping between the relational tables and the resulting XML document. Based on the mapping defined by the view query, a portion of the database can be exported as XML.

When there are updates to the XML view of the relational data, such updates generally need to be reflected in the underlying relational database well. Update operations, however, are not well supported, particularly when the underlying relational database not only serves XML applications, but also is accessed directly by relational applications. A need therefore exists for an improved method and apparatus for updating XML views of relational data. A further need exists for methods and apparatus to translate an XML update into update operations on the underlying relational database.

### SUMMARY OF THE INVENTION

Generally, a method and apparatus are provided for updating XML views of relational data. The present invention translates an update to an XML view of a relational database into update operations to be performed on the underlying relational database itself. The disclosed XML view update manager can perform updates in the context of an underlying relational database that serves the XML-based application, as well as traditional relational database management system (RDBMS) applications. Given a preexisting underlying relational-database schema and an XML view defined on it, the present invention provides a framework for generating update plans to perform an update without introducing side-effects to other parts of the view.

The disclosed XML view update manager provides side-effect checking, Document Type Definition (DTD) validation, constraint checking, and finally update translation and execution. The disclosed XML view update manager employs algorithms for update translation that are based on a framework for the determination of element updatability and the resulting impact on underlying tables. After breaking up update operations into various sub-tasks, such as DTD validation, constraint checking, and translation, each sub-task is assigned to the XML view side or the relational database side, as appropriate. Effective mechanisms are presented to deal with constraints, re-organizing constraints from the database schema as well as the view schema, to improve performance. Finally, the main part of the view update architecture is implemented in an existing system. In one implementation, the XML view update manager distributes the update subtasks between the view and underlying database, relying on a layer where efficiency is higher.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional relational database and its schema for a first example;

FIG. 2 illustrates a view definition that defines the generation of an XML view from a relational database;

FIG. 3 illustrates the resulting XML document fragment generated based on the view of FIG. 2 and the relational database of FIG. 1;

FIG. 4 illustrates a different set of base tables with a different relational schema generated from the view of FIG. 2 in accordance with a conventional inlining algorithm;

FIG. 5 illustrates a relational schema for a second example;

FIG. 6 illustrates a view definition that defines the generation of an XML view from a relational database;

FIG. 7 illustrates a relational schema generated from the view of FIG. 6 in accordance with a conventional inlining algorithm;

FIG. 8 illustrates an underlying database schema for a third example;

FIG. 9 defines an XML view for the third example;

FIG. 10 illustrates a view-relationship graph for the third example;

FIG. 11 illustrates exemplary pseudo-code for a node categorization process incorporating features of the present invention;

FIG. 12 illustrates exemplary pseudo-code for a deletion translation process incorporating features of the present invention;

FIG. 13 is a schematic diagram of the architecture of an XML view update manager incorporating features of the present invention;

FIG. 14 illustrates the various constraint categories employed by the XML view update manager of FIG. 13; and

FIG. 15 illustrates a XML view update manager in which the present invention may be employed.

### DETAILED DESCRIPTION

The present invention provides an XML view update manager 1300, discussed further below in conjunction with FIG. 13, that updates XML views of relational data. The XML view update manager 1300 translates an update to an XML view of a relational database into update operations to be performed on the underlying relational database itself.

### XML Views of Relational Databases

XML-based applications are often built upon an existing relational database that serves traditional Relational Database Management System (RDBMS) applications as well. There are three characteristics of this architecture: (1) the relational database schema and constraints are predefined; (2) the XML view is defined based on the database; and (3) the XML view and updates through that view are always synchronized with the base (relational) data.

A suitable declarative language to extract data from an existing relational database and generate an XML version of data is provided by the ROLEX system, as modified herein to provide the features and functions of the present invention, as described, for example, in P. Bohannon et al., “Optimizing View Queries in ROLEX to Support Navigable Result Trees,” Proc. of the 28^{th} Int'l. Conf. on Very Large Data Bases (2002), incorporated by reference herein. Generally, the ROLEX system provides all of the basic features of standard commercial relational products. Regardless of the specific underlying relational system, the techniques of the present invention for supporting updates through XML views allow such issues as concurrency, recovery, and many aspects of consistency and integrity checking to be performed by the underlying database system. This contrasts to XML-publishing environments or commercial relational systems, in which each application typically caches its own materialized XML view and much of the capability of the underlying database system goes unused.

### XML Shredding

Recent work on XML updates studies the problem of updating the underlying relational database in the context of XML shredding using the inlining method. See, I. Tatarinov et al., “Updating XML,” Proc. of the 20^{th} ACM-SIGMOD Int'l Conf. on Management of Data (2001). Generally, inlining defines a specific procedure for the conversion of a given XML schema into a relational schema and the storage of XML data in a relational database conforming to that schema. The original XML schema alone determines the update strategy.

The present invention, on the other hand, considers the relational schema as predefined. Both the relational schema and the XML schema form the input of the update problem. Consequently, many more possible cases need to be considered. The solution must be general and flexible enough to deal with any XML view over any relational schema. In particular, the present invention is suitable for existing relational databases that are now to be accessed by XML-based applications as well.

### EXAMPLES

Two examples demonstrate the complexity in handling the side-effects of updates and contrast the assumptions of updating the underlying relational database in the context of XML shredding using the inlining method with those of the present invention:

### Example 1

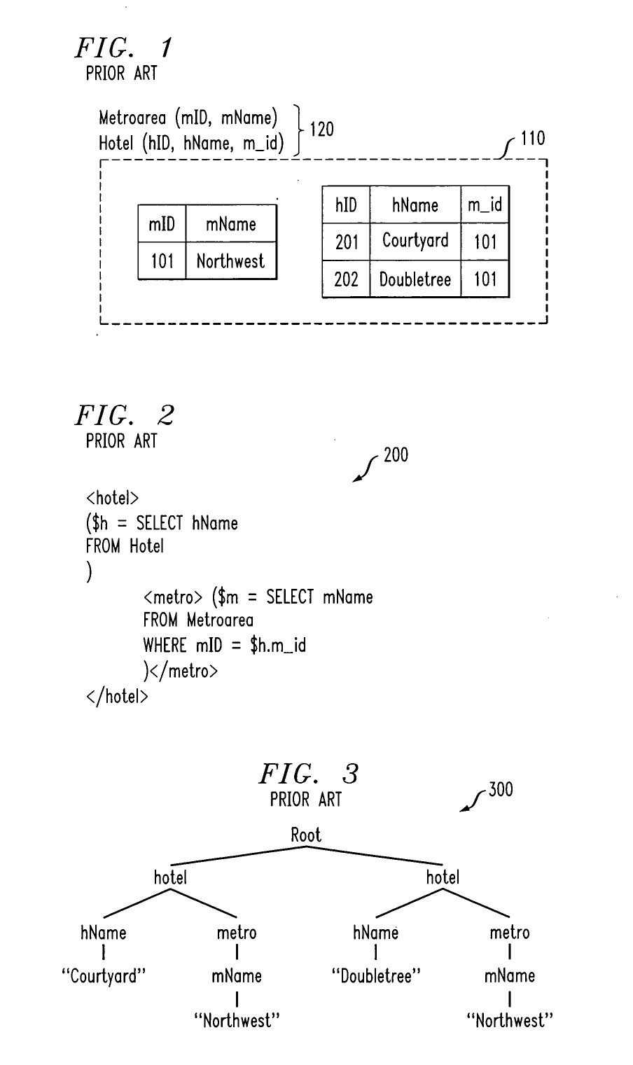

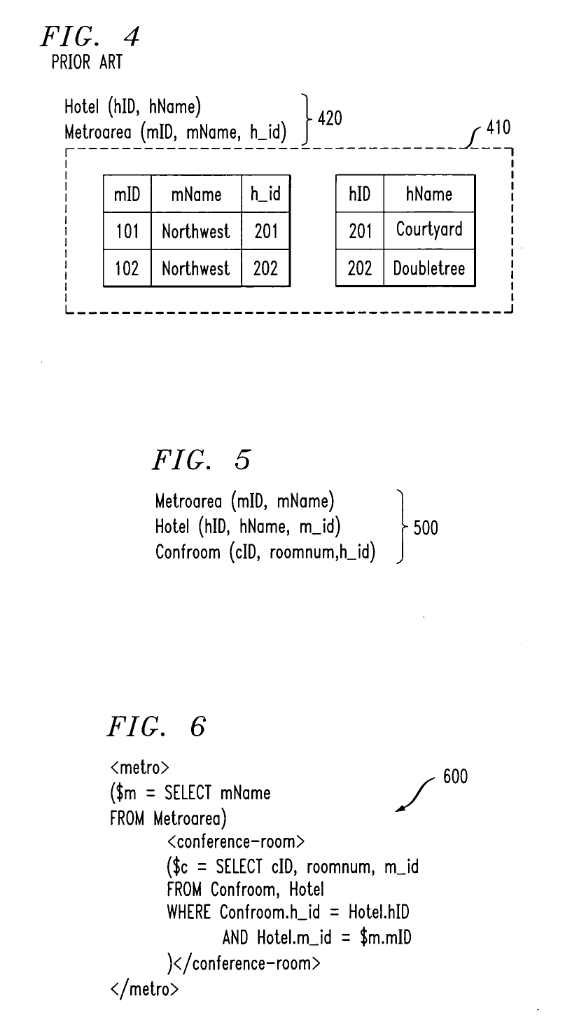

FIG. 1 illustrates a conventional relational database 110 and its schema 120. Given the relational database 110 and its schema 120, and the view definition 200 (updating the underlying relational database in the context of XML shredding using the inlining method), shown in FIG. 2, the resulting XML document fragment 300 is shown in FIG. 3. Using the inlining algorithm described by J. Shanmugasundaram et al., a different set of base tables 410 with a different relational schema 420 would be generated from the view 200, as demonstrated in FIG. 4. In the latter schema 420, the Metroarea relation, rather than the Hotel relation, has a foreign key. Instead of having a single tuple for each metro area, there is a separate Metroarea tuple for each hotel. When a hotel node in the document is deleted, it is easy to see that all the tuples related to its children nodes, more specifically, the related Metroarea tuples must be deleted. However, in the original database 110 of FIG. 1, the Metroarea tuple must be preserved for other hotels. Since the update techniques of the present invention permit either database schema as the underlying schema, a way to distinguish them and give different update plans is required.

### Example 2

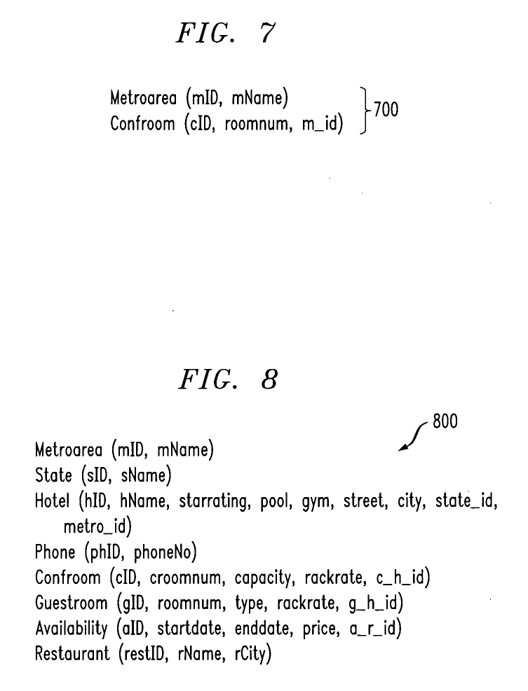

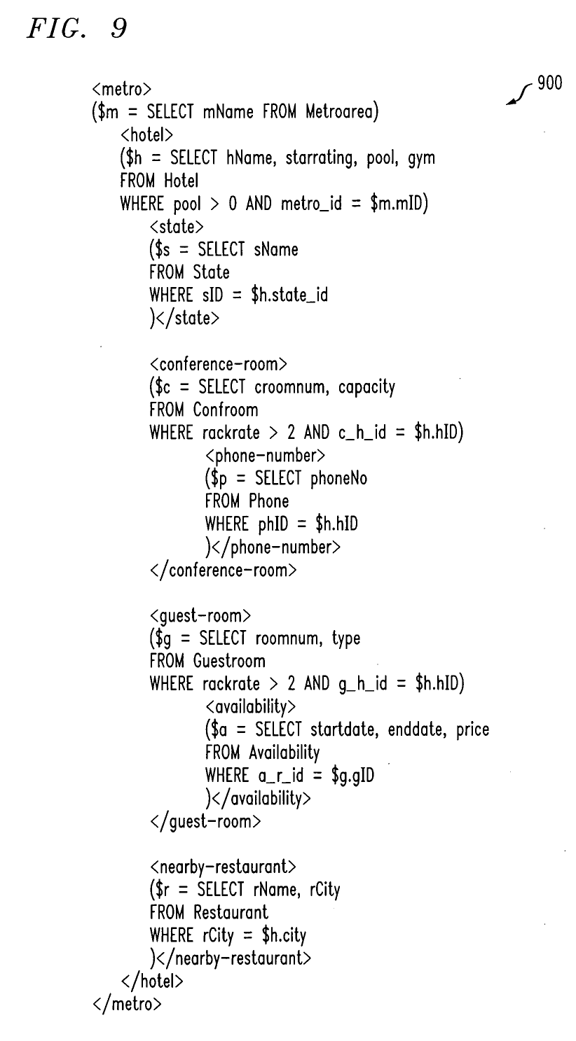

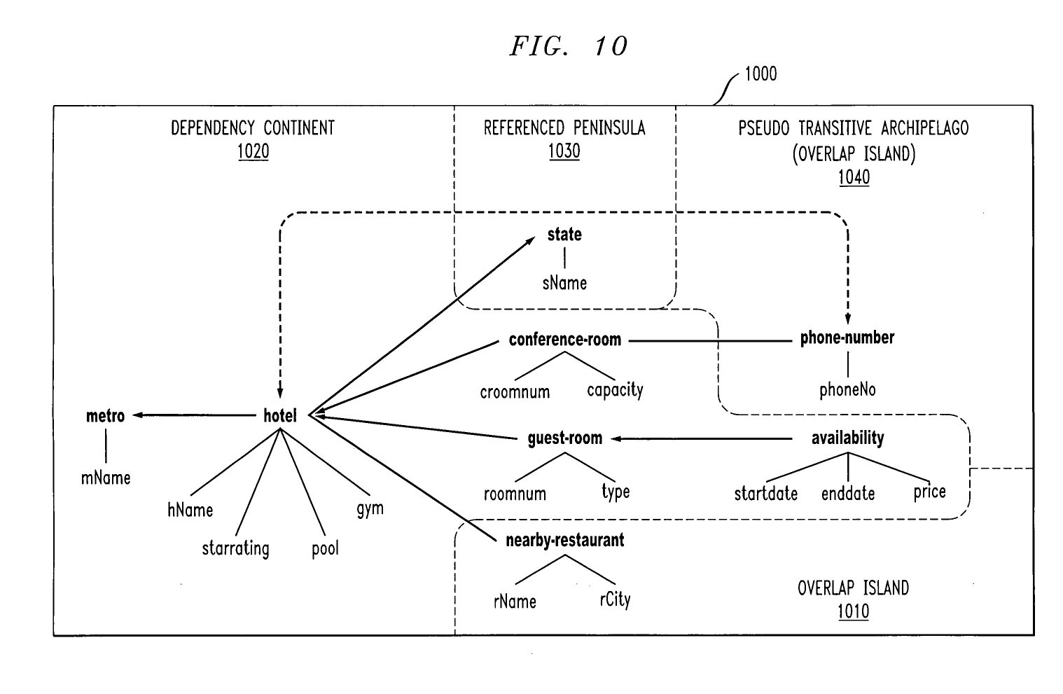

FIG. 5 shows a relational schema 500, and FIG. 6 shows a view definition 600. The original relational schema 600 is made up of three relations, while the inlining-generated schema 700, based on the XML view, shown in FIG. 7, consists of only two relations. Given the latter schema 700, the deletion of a metro node can be executed in a straight-forward manner by propagating the deletion to the Confroom table. If the same thing was done under the original relational schema 500, the Hotel table is affected due to the foreign-key constraint. As the Hotel table is invisible to the XML application, any operation on it is considered undesirable.

The above examples show that updates through XML views are more challenging to manage when the underlying relational database schema is not the one derived from the view via inlining. The challenge arises from the fact that the XML view does not determine a unique relational database schema, and so, assumptions about the specific nature of the database schema cannot be built into the view-update algorithms.

### View Updates

The view-update problem in relational databases is a long-standing issue that has been studied extensively. A survey of research on the view-update problem is presented in A. Furtado and M. Casanova, “Updating Relational Views,” in W. Kim et al., eds., Query Processing in Database Systems, Springer-Verlag Topics in Information Systems, 127-44 (1985). There are three practical approaches addressing the view-update problem. One is to regard the underlying database and the view as abstract data types, with the updating operations predefined explicitly by the DBA. The second determines a unique or a small set of update translations based on the syntax and semantics of a view definition. The second approach, given that the underlying base tables are in Boyce-Codd-Normal-Form (BCNF), generates a query graph for the select-project-join view, and, based on the graph, gives a list of templates for possible translations of deletion, insertion and replacement operations on the view into certain update operations on the underlying database. This work has been extended for object-based views. The third approach performs run-time translation from the view-update problem into the constraint-satisfaction problem (CSP), with the exponential time complexity in the number of constraint variables.

The XML view-update algorithm according to the present invention follows the line of the second approach. It shares the basic idea of deriving update methods from the view definition. The object concepts of T. Barsalou et al. “Updating Relational Databases Through Object-Based Views,” Proc. of the 10th ACM SIGACT-SIGMOD Symposium on Principles of Database Systems (1991) are adapted in the XML-based model of the present invention. However, the XML model has features that distinguish it from the object model. For example, the XML document helps decide the propagation direction. In Example 1, regardless of whether the table Hotel has the foreign key pointing to Metroarea or vice versa, the propagation should follow the direction from Hotel to Metroarea. On the other hand, the possibility of repeating certain data in different parts of an XML hierarchy raises more restrictive preconditions for an XML view to be updatable. Moreover, as an element can correspond to either a tuple or a field, the same type of update operation in XML needs to be translated into different kinds of relational update operations. Finally, some special XML view features such as transitive relationships and IDREF references, discussed below, bring more complication into the problem.

According to one aspect of the present invention, an XML view update manager 1300, discussed further below in conjunction with FIG. 13, provides side-effect checking, DTD validation, constraint checking, and finally update translation and execution. The disclosed XML view update manager 1300 employs algorithms for update translation that are based on a framework for the determination of element updatability and the resulting impact on underlying tables. After breaking up update operations into various sub-tasks, such as DTD validation, constraint checking, and translation, each sub-task is assigned to the XML view side or the relational database side, as appropriate. Effective mechanisms are presented to deal with constraints, re-organizing constraints from the database schema as well as the view schema, to improve performance. Finally, the main part of the view update architecture is implemented in an existing system.

### XML View-Update Problem Definition

Initially, the set of allowed update operations are identified:

XML Update Syntax and Semantics

P. Lehti, “Design and Implementation of a Data Manipulation Processor for an XML Query Language,” Technical Report, Technische Universitat Darmstadt, Report KOM-D-149 (2001) provides a suitable syntax for the expression of XML updates. Regardless of the specific syntax used for XML updates, they can be divided into several categories as discussed below.

The first distinction is drawn among nodes of an XML document that are materialized from an XML view. A text node in an XML document represents the string or numeral value of a PCDATA element or an attribute, referred to as a value. A non-text node (or node, when no confusion arises) is one that is not a value. Update operations are examined only on nodes and not on values, as the latter can be transformed easily to the replacement of a node. Among the nodes in an XML document, the node representing a PCDATA element or an attribute is called a leaf node. Other non-root nodes are called branch nodes.

XML update operations are considered that touch the data but not the tags. Tag modification would result in schema change. Data-update operations include deletion, insertion, movement, and replacement. In an XQuery-based syntax, these operations make use of the XQuery FLWR (FOR, LET, WHERE) statements: iterator, assignment, and conditional to locate the nodes for updates. Order issues are ignored because the view-definition language used in the ROLEX system does not offer a mechanism to define element order. These operations may be categorized as follows:
A deletion is the removal of the indicated node, as well as any nodes or values contained under the selected node. Stated in terms of an XML document, the delete operation removes the entire subtree rooted at the selected node. A node that is the obligatory child of its parent node according to DTD cannot be removed. A node referenced by other nodes using IDREF cannot be removed.
An insertion adds a node together with its descendants and values under a parent node. In an XML document, the operation inserts a subtree into a certain location. The entire subtree is given in the insertion command. The insertion of a node not conforming to the DTD or a node referencing, by IDREF, non-existing nodes is not allowed.
A movement moves the node together with its descendants and values from the old position to the new position, under another node with the same type as its original parent. DTD cardinality constraints must be observed. Note that a movement does not equal deletion followed by insertion because movement preserves the identity of the node.
A replacement can be regarded as deleting the old node and inserting the new node in one transaction. DTD consistency and IDREF consistency need to be enforced with regard to the replacement as a whole. The deletion and insertion steps of a replacement may cause a temporary violation of constraints.

Finally, in an XML view, data from a relational tuple could appear in multiple parts of the XML document based on the view definition. The discussion herein is based on the assumption that when a user updates a node in the XML view, the user means to update that specific part and does not expect any changes to the rest of the view. In other words, the update on the indicated piece of data should be fulfilled while keeping the rest of the view intact. This is in contrast to the approach taken by T. Barsalou, where changes to the indicated object may be cascaded to other instances in the object view. However, the framework can be easily modified to allow cascades of updates to various parts of the materialized document.

Problem Definition and Assumptions

The problem to be solved is defined as follows: given an underlying relational database and its schema, and an XML view definition over that database, how should the system translate an update against the XML view into corresponding updates against the underlying database without violating consistency? “Consistency” means that three criteria must be satisfied. First, updates should be side-effect free. That is, the semantics of the update performed on a materialization of the view must yield the same result as the regeneration of the XML view after performing the translated update on the underlying database. If a side-effect free translation does not exist, the specific node is non-updatable. Second, the updated XML view must be consistent with the view definition and the DTD explicitly given in or derived from the view definition. Third, the updated data in the underlying database must comply with the relational schema and the constraints for the underlying database.

The discussion is based on the ROLEX system view-definition language although the presented algorithms can be modified easily for other XML view-definition languages. Predicates appearing in the WHERE clause are divided into two parts. The predicates involving binding variables are called correlation predicates. The other predicates are called non-correlation predicates. The correlation predicates indicate the relationships among XML nodes. When the correlation predicates are removed, each SQL query for a single node can be regarded as a relational view that is isolated from any other nodes, referred to as an element base view.

The following assumptions are made herein:
There are no aggregates, order-by, or group operations. These operations usually make views non-updatable, as was established for relational views.
The underlying relational database is in BCNF (for preservation of data dependencies).
An element does not have more than one child node with exactly the same type and the same content.

XML View Update Example

The running example used hereinafter is drawn from a conference-planning application.

### Example 3

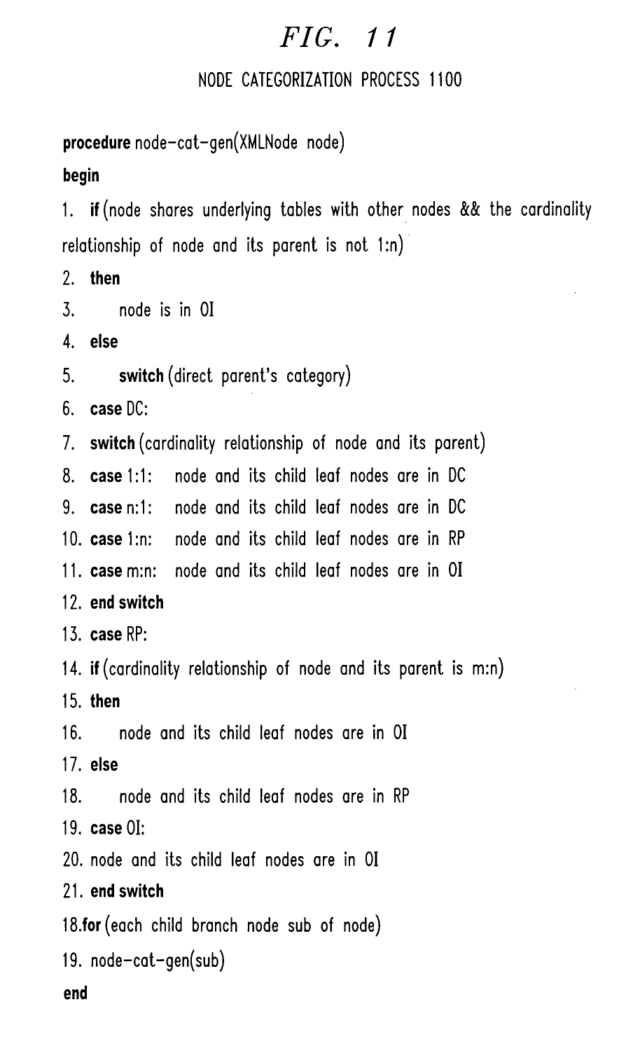

FIG. 8 shows the underlying database schema 800. FIG. 9 defines the XML view 900. From the foreign-key constraints of the underlying database (not shown), the relationship of view nodes metro:hotel are determined to be one-to-many (1:n), hotel:state are determined to be many-to-one (n:1), hotel:conference-room are determined to be 1:n, hotel:guest-room are determined to be 1:n, guest-room:availability are determined to be 1:n, hotel:nearby-restaurant are determined to be many-to-many (m:n), and hotel:phone-number are determined to be one-to-one (1:1). (1:1 comes from the fact that phID acts both as the key and the foreign key of Phone; as a foreign key, it references to hID in the Hotel relation.)

### Update Translation Algorithms

Overview

As any XML update is based on a subtree instead of a single node, the particular update may affect many nodes in the subtree besides the indicated node itself. As a result, during translation, while considering the updates against the relational tuple(s) corresponding to the node itself, the tuples related to the descendant (or child) nodes must also be considered. This process is called propagating the update from the parent-node element base view to the child-node element base views.

Given an update on an XML node, XML view update manager 1300 decides (1) whether the node is updatable for that specific update type; (2) how to propagate the update; and (3) what type of updates (insert, delete, replace) should be performed on the element base view(s). These decisions are made by examining the view-relationship graph that describes the relationships between node pairs in the XML view. Based on the decisions, the XML view update manager 1300 proposes an update plan on the element base view(s). Then, a relational view-update algorithm, such as the one described in A. M. Keller, “Algorithms for Translating View Updates to Database Updates,” Proc. of the 4^{th} ACM SIGACT-SIGMOD Symposium on Principles of Database Systems (March 1985), is used to obtain the correct update plan on the underlying relational database.

In the remaining sections, the algorithm is presented to generate the view-relationship graph and the update plan for a basic case in which correlation predicates are between a parent node and a child node. Then the algorithm is extended to tackle correlation predicates between a node and its any ancestor. Finally, the changes needed to manage IDREF attributes are discussed.

XML View-Relationship Graph

To visualize the relationships between node pairs in the XML view, the XML view is transformed into an XML view-relationship graph. In an XML document, element tags and attribute names indicate the type of the node. A node M is called the direct parent of node N, if M is the parent of N in the XML view; N is called the direct child of M. In the view-relationship graph, annotated edges are added between each node and its direct parent to indicate the cardinality relationship. “←” annotates a 1:n relationship, “→”annotates a n: 1 relationship, “ [symbol] ” annotates a 1:1 relationship, and finally “-” annotates a m:n relationship. The view-relationship graph 1000 for the running example is shown in FIG. 10. The root of the view-relationship graph is the node corresponding to the root of the XML view document.

The cardinality relationship of a node pair is decided by correlation predicates in the view definition. If the correlation predicate in the child node is of the form ForeignKey=$bindingVar.Key, where $bindingVar represents the direct parent node, the relationship between the direct parent and the child is 1:n. If the correlation predicate is of the form Key=$bindingVar.ForeignKey, the relationship between the parent and the child is n:1. If the foreign key also acts as a key for the element base view, the relationship is labeled 1:1. If there is no correlation predicate between the parent and the child, or the predicate is not equality, or the comparison is not between a foreign key and its referenced key, then the relationship is labeled m:n. If there are several correlation predicates between the same pair of nodes, the precedence of 1:1, n:1, 1:n, and m:n is followed, (highest to lowest), to assign a cardinality relationship. In the above discussion, the terms key and foreign key refer to those of the element base view. For instance, in Example 2, the key of the node conference-room is Confroom.cID, and the foreign key is Hotel.m_id.

According to the cardinality relationship between node pairs, we partition the graph into categories. In T. Barsalou, relations are grouped into categories based on object definition, including subset, ownership and reference relationships, which imply 1:1, 1:n and n:1 cardinality relationships respectively. The many-to-many relationship is not considered. The categorization employed by the present invention is based entirely upon cardinality relationships indicated by foreign-key constraints in the underlying relational database. This helps capture more semantics information. Because of the motivation provided by T. Barsalou, a convention similar to their work is employed in naming categories shown in FIG. 10

Definition 1: An overlap island (OI) 1010 is a maximal subtree of the view-relationship graph with a root N that satisfies one of the following:
1) N has a direct parent outside the overlap island, and the relationship between N and its direct parent is m:n;
2) There are other nodes that get non-exclusive data from the same relation as N, and N has a relationship other than 1:n with its parent.

(Certain overlap islands will be identified in the section below entitled “Extended Algorithm for Transitive Relationships” as falling into the special category of transitive archipelagos.)

The root of the subtree is an OI-root. A node in the XML document that corresponds to a node in an overlap island is an OI-node. If it corresponds to an O-root, it is an OI-root-node.

Observation 1: Given an OI-root-node, its direct parent can have more than one direct child node of its type. For any OI-node N, other nodes in the XML document may obtain their values from the same relation tuple(s) as N.

Definition 2: The dependency continent (DC) 1020 is a maximal subtree of the view-relationship graph such that all of the following hold:
1) The root of the subtree is the root of the view-relationship graph;
2) The cardinality relationship between a branch node in the subtree and its direct parent is 1:1 or n:1;
3) No node in the subtree is a node in an overlap island.

A node in the XML document that corresponds to a node in the dependency continent is a DC-node.

Observation 2: For a given view-relationship graph, there exists only one dependency continent. Each branch node in the dependency continent has a 1:1 or n:1 relationship with its direct parent, and thus 1:1 or n:1 relationship with the root of the view-relationship graph. Given a DC-node N, no other node in the XML document obtains its value(s) from the same relation tuple(s) as N.

Proposition 1: Given a DC-node, all its ancestor nodes are also DC-nodes.

Definition 3: A referenced peninsula (RP) 1030 is a maximal subtree of the view-definition graph such that both of the following hold:
1) The root R of the subtree has a direct parent in the dependency continent, and the relationship between R and its direct parent is 1:n;
2) No node in the subtree is a node in an overlap island.

The root of the subtree is called an RP-root. A node in the XML document that corresponds to a node in the referenced peninsula is called an RP-node. If it corresponds to an RP-root, it is called an RP-root-node.

Observation 3: Given an RP-root-node, its direct parent has only one direct child node of its type. For any RP-node N, other nodes in the XML document may obtain their values from the same relation tuple(s) as N.

Certain XML document nodes have their data in the view only once. Such nodes form the dependency continent. The other nodes may have duplications in the view. If multiple direct-parent nodes reference the same data via a foreign key, which implies the parent node can have just one child node of the given type, then the child node constitutes the root of the referenced peninsula. Else, if a direct parent can have multiple child nodes of the same type, we categorize the child nodes as being in an overlap island. The theorem below follows from this discussion.

Theorem 1: The dependency continent, referenced peninsulas, and overlap islands (including those overlap islands characterized in the section below entitled “Extended Algorithm for Transitive Relationships” as transitive archipelagos) form a partition of the view-relationship graph.

In the view-relationship graph for the running example, the dependency continent includes nodes metro, hotel, conference-room, guest-room, availability, and their child leaf nodes. There is one referenced peninsula, which has the node state as its RP-root and the child leaf nodes of state. The node nearby-restaurant and phone-number, together with their child leaf nodes, form two overlap islands. The phone-number element is discussed further below in the section entitled “Extended Algorithm for Transitive Relationships.”

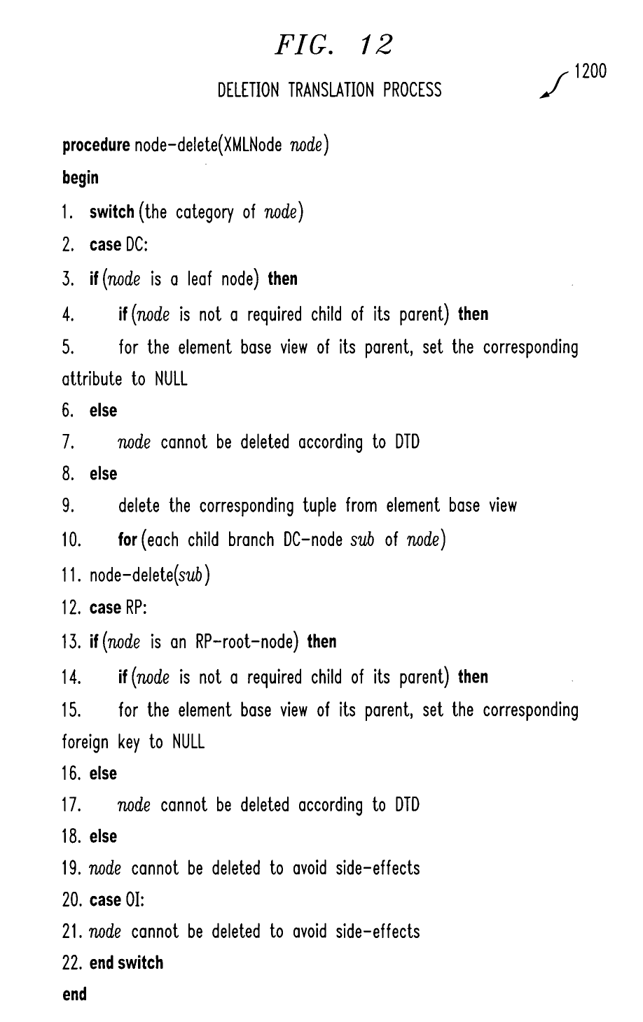

FIG. 11 illustrates exemplary pseudo-code for a node categorization process 1100 incorporating features of the present invention. The algorithm 1100 assigns categories 1010, 1020, 1030 to each XML view node. The category assignment can be done in a single traversal of the view-relationship graph. Hence, the time complexity is O(n), where n is the number of nodes in the graph.

Update Propagation Algorithm

The updatability property and the update execution strategy of each category are different. The set of possible updates are organized by node category (DC 1020, RP 1030, OI 1010) and by operation (insert, delete, move, replace). According to the update semantics described above in the section entitled “XML Update Syntax and Semantics,” when a node is updated, both the node itself and the entire subtree rooted at the node are affected. The execution strategies employed herein follow the following principles:
1) No side-effects.
2) One step changes: only one step of the update execution affects a given tuple.
3) Minimal changes: no other valid strategy would require a proper subset of the database update operations.
4) Simplest replacement: no other valid strategy would make a simpler change such as a proper subset of the attributes.
5) No insert-delete pairs: replacements used instead.

The intuition for the update strategy is as follows: Updating a node may cause side-effects if and only if the underlying data to be updated appears in other parts of the view. Observation 2 indicates that a DC-node can be updated without causing side-effects. According to Observation 3, RP-root-node updates are allowed because they can be achieved by replacing the related foreign-key values for their direct parents, which are DC-nodes. Other nodes cannot be updated because of non-avoidable side-effects. To enforce foreign-key constraints for the underlying relational database, in certain cases deletions must be propagated recursively from a parent node to its child nodes, so as to eliminate tuples containing a foreign-key value referencing the deleted tuple(s). The detailed update strategy is given below:

Deletion of a branch DC-Node:
1) Delete the corresponding tuple in the element base view.
2) Propagate the deletion recursively to all branch DC-children of the deleted node.

Insertion of a Branch DC-Node:

Insertion is allowed only when all of the following hold (conditions):
1) The OI-descendants of the inserted node, as given in the insertion, include exactly those descendant nodes that can be derived from existing tuples in the database that satisfy the correlation predicate(s).
2) Each branch node in the inserted subtree has a leaf child corresponding to the key of the element base view.

Insertion is performed as follows (execution steps):
1) Insert the corresponding tuple, with the foreign-key values equal to the key values of its direct parent, into the element base view.
2) Propagate the insertion recursively to all branch DC-children of the inserted node.
3) Propagate the insertion to its branch RP-descendants that contain new values. (Note that this is not a recursive process because according to the rules discussed below, non-root RP-nodes cannot be inserted.)

Movement of a Branch DC-Node:

Movement is allowed only when the foreign key in the node to be moved does not itself appear in the view as a leaf node.

Movement is performed by setting the foreign-key values in the element base view of the DC-node to the key values of its new direct parent.

Deletion of a Leaf DC-Node:

Deletion of a leaf DC-node is allowed only when the node does not correspond to a foreign key appearing in correlation predicates.

Deletion is performed by setting the corresponding attribute in the element base view to NULL.

Insertion of a Leaf DC-Node:

Insertion is allowed only when the leaf node does not correspond to a foreign key appearing in correlation predicates.

Insertion is performed by assigning a value to the corresponding attribute in the element base view.

Deletion of an RP-Root-Node:

Deletion of an RP-root-node is allowed only when the foreign key of the parent node does not appear in the view as a leaf node (within the parent).

Deletion is performed by setting the foreign-key values in the element base view of its direct parent to NULL.

Insertion of an RP-Root-Node:

Insertion is allowed only when all of the following hold:
1) The foreign key of the parent node does not appear in the view as a leaf node (within the parent);
2) The OI-descendants of the inserted node, as given in the insertion, include exactly those descendant nodes that can be derived from existing tuples in the database that satisfy the correlation predicate(s).
3) Each branch node in the inserted subtree has a leaf child corresponding to the key of the element base view.

Insertion is performed as follows:
1) Set the foreign-key values in the element base view of its direct parent to the key values in its element base view;
2) Insert the corresponding tuple into the element base view if the inserted node contains new values;
3) Propagate the insertion to its branch RP-descendents that contain new values.

Updates of a Non-Root RP-Node: not Allowed.

Updates of an OI-Node: not Allowed.

The rules for replacement and movement are not enumerated, with the exception of branch DC-nodes, as they can be easily derived from the rules for deletion and insertion, as would be apparent to a person of ordinary skill in the art.

Proposition 2: The update propagation algorithm correctly translates the updates on the XML view into the updates on the element base views that observe the 5 principles of A. M. Keller.

Given above update strategies, algorithms to generate the update plan can be developed. As an example, the algorithm for translating the deletion of a node from an XML view document into the element base view(s) updates is discussed. In addition to considering side-effects, not-null constraints are taken into consideration, and explored further below.

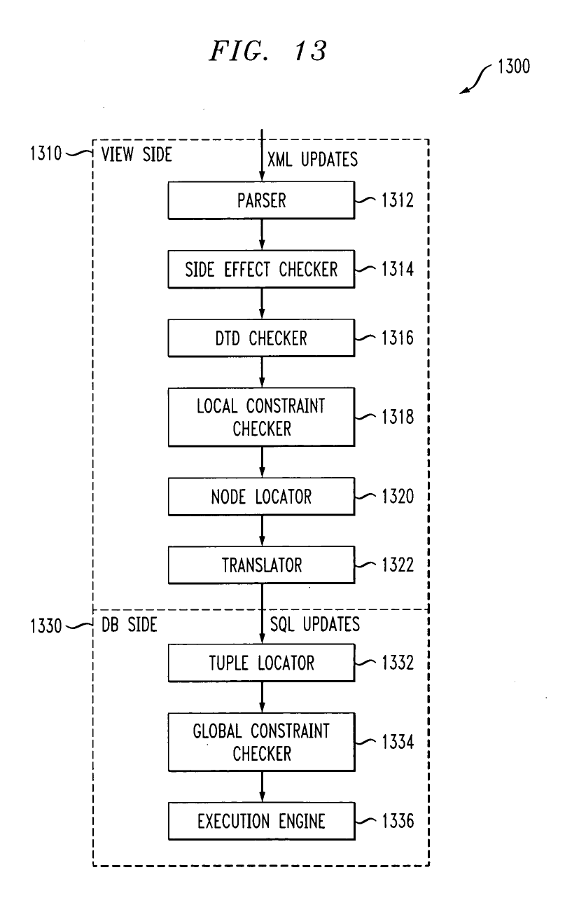

FIG. 12 illustrates exemplary pseudo-code for a deletion translation process 1200 incorporating features of the present invention.

Extended Algorithm for Transitive Relationships

The relationship between a node and its direct parent is referred to as a direct relationship, and the relationship between a node and its ancestors other than its direct parent an indirect relationship. In Example 3, the node phone-number has a m:n direct relationship with its parent conference-room. In addition, it has an indirect relationship with its ancestor hotel. The correlation predicate of phID=$h.hID indicates that the cardinality relationship between hotel and phone-number is 1:1. This case was not covered above.

Definition 4: A transitive relationship is a non-m:n relationship defined by a correlation predicate between a node and an ancestor node other than its direct parent. The ancestor is called its transitive parent.

Definition 5: A transitive relationship is called an effective transitive relationship if both of the following hold:
1) The child node N has a m:n relationship with its direct parent P;
2) Node N has a transitive relationship with some ancestor T.

T is called a real transitive parent of N. N is called a real transitive child of T, and a pseudo child of P.

Observation 4: Given a node that has a 1:1 or 1:n relationship with its real transitive parent, its direct parent has no more than one child node of its type. Given a node that has a n:1 relationship with its real transitive parent, its direct parent can have more than one child node of its type.

In Example 3, there exists an effective transitive relationship between the node phone-number and hotel. The node phone-number is a real transitive child of the hotel node and a pseudo child of conference-room. Because the cardinality relationship between hotel and phone-number is 1:1, each conference-room node can have no more than one phone-number child.

Definition 6: A transitive relationship is called a double transitive relationship if all of the following hold:
1) The child node N has a non-m:n relationship with its direct parent P;
2) N has a transitive relationship with some ancestor T;
3) The direct or indirect relationship between T and P is m:n.

T is called the double transitive parent of N. N is called a double transitive child of T.

Observation 5: Given a node that has a 1:1 or 1:n relationship with either its direct parent or double-transitive parent, its direct parent has no more than one child node of its type. Given a node that has n:1 relationships with both its direct parent and its double-transitive parent, its direct parent can have more than one child node of its type.

In the view-relationship graph 1000, an annotated dotted edge is added between a node and its transitive parent.

Definition 7: A transitive archipelago (TA) 1040 is a maximal subtree in the view-relationship graph 1000 with a root node that has a DC-node or an RP-node as its real transitive parent or double transitive parent. The root of the transitive archipelago is called a TA-root. A TA-root that has a n: I relationship with its effective transitive DC-parent or has n:1 relationships with both its direct DC-parent and its double transitive DC-parent is a TA-DC-root; the rest TA-roots are TA-RP-roots. A node in the XML document that corresponds to a node in the transitive archipelago is a TA-node. If it corresponds to a TA-root, it is a TA-root-node.

The nodes in the transitive archipelago 1040 are divided into transitive DC-nodes, transitive RP-nodes and transitive OI-nodes according to a categorization similar to that described above in the section entitled “XML View-Relationship Graph.”

Observation 6: A transitive archipelago is a subset of an overlap island.

Definition 8: A pseudo transitive archipelago (PTA) 1040 is a transitive archipelago in which the transitive parent and the direct parent of the root node have a direct or indirect relationship between them that is m:n or 1:n. The root of the subtree is called a PTA-root. A node in the XML document that corresponds to the node in the pseudo transitive archipelago is a PTA-node. If it corresponds to a PTA-root, it is a PTA-root-node.

Observation 7: Given a PTA-root-node N, its transitive parent node P may have more than one descendant node of the same type as N's direct parent node, and thus, may have more than one transitive child node that obtains its value from the same relation tuple as N.

Observation 8: Given a non-PTA TA-node N, its transitive parent node P has only one descendant node of the same type as N's direct parent node, thus no other nodes in the subtree rooted at P obtain their values from the same relation tuple as N.

Notice that the update-propagation algorithm described in the section entitled “Update Propagation Algorithm,” neither allows any update to overlap islands, nor propagates any update to OI-descendant nodes. With the introduction of transitive relationship and transitive archipelagos, the special subareas of overlap islands, the algorithm must be adjusted in the following aspects:
Propagation to transitive children: apply the propagations described in the algorithm to the transitive TA-children and their descendant nodes, in the same manner as for non-transitive descendant nodes in corresponding categories.
Updates of a non-PTA TA-node: apply the same algorithm as that for a non-TA-node in the corresponding category.
Updates of a PTA-node: not allowed.

The idea behind the above update strategy is that a TA-node that is not a PTA-node, does not share data with other nodes in the subtree rooted at its transitive parent, and thus can be treated the same as a non-TA-node in the corresponding category. This can be inferred from Observation 8. However, according to Observation 7, a PTA-node could possibly be sharing data with other nodes in the subtree rooted at its transitive parent. Therefore, to avoid side-effects, updates on the node are not allowed, but propagations from the transitive parent to all such descendants are permitted.

In Example 3, the node phone-number belongs to a pseudo transitive archipelago, thus cannot be updated. While the updates of the node Hotel need to propagate to it, the updates of the node conference-room have no effect on it.

Proposition 3: The update propagation algorithm after the adjustments described above correctly implements the updates and observes the five principles of A. M. Keller.

Double transitive relationships and effective transitive relationships cover the cases where either transitive parent-direct parent relationship, or direct parent-child relationship, has m:n cardinality. If both are non-m:n, the problem can be transformed to the cases discussed above, by removing the transitive parent-child relationship or the direct parent-child relationship without changing the update semantics. Furthermore, the algorithm can be easily extended to handle the case where a node has several transitive relationships with different ancestors.

Extended Algorithm with IDREF

IDREF attributes are specific to XML documents. A node referenced by other nodes using IDREF attributes is called a referenced node. The IDREF attribute nodes referencing it is called referencing nodes. Double lines are added in the view-relationship graph 1000 between the referenced node and its referencing nodes, with the arrow pointing to the referenced node A referenced node has exactly the same updatability and update plan as common nodes in the same category, except that deletions are not allowed on a node being referenced by other nodes. Usually, referenced nodes are in the dependency island and can be safely updated.

The referencing node is an IDREF attribute node, thus a leaf node. It is treated the same as other leaf nodes in its category except that during insertion, we need to guarantee the existence of the referenced nodes.

Completeness of the Algorithm

Proposition 2 and 3 indicate the soundness of the update algorithm. Proposition 4 characterizes the scope of the algorithm.

Proposition 4: Direct relationships, transitive relationships and IDREF reference relationships cover all explicitly given relationships in an XML view definition.

### System Architecture

FIG. 13 is a schematic diagram of the architecture of an XML view update manager 1300 incorporating features of the present invention. To update the XML view, the system 1300 needs to parse a given update command, locate nodes for update in the XML document or directly locate related tuples in the database, translate the XML-view update into updates against underlying relations, and finally execute the updates. In addition, consistency checks need to be enforced, which may include avoiding side-effects, DTD validation, view-definition predicate checking, and database-constraint enforcement.

As shown in FIG. 13, the exemplary XML view update manager 1300 divides these tasks between a view side 1310 and an underlying database side 1330. This division is necessary, as neither level alone can suffice.

System Description

To attain higher efficiency, part of the work is completed at the view level, which means the view-level middleware system takes a first pass at the update task instead of relying on the underlying database. There are three advantages for this approach. First, doing consistency testing early and in turn finding invalid updates early can save unnecessary work in the underlying relational database. Second, static information can be collected from the view definition and the underlying relational database schema at the time of parsing the view-definition. This information, stored at the view level, can be used during the view-update process to improve performance. Third, when the work is done at the view side, better knowledge is available about the remaining update task, and therefore, can take advantage of that knowledge in optimizing the operations on the underlying database. On the other hand, the database side is more efficient at accessing data. So any update operation or constraint checking that needs ancillary data for support is assigned to the database side.

At the view side 1310, the parser 1312 accepts the view update command and gets information about the node to be updated, such as its tag or attribute name, the contents for insertion or replacement, and the XPath and XQuery predicates for location. After that, the side-effect checker 1314 decides whether the node can be updated without causing side-effects. Then, the DTD checker 1316 determines whether the node is updatable according to the DTD, and whether the segment for insertion or replacement follows the DTD. If the DTD is not explicitly given, it can be derived from the XML view definition and the underlying relational database schema. Next, a local constraint checker 1318 checks local constraints, including whether the inserted data violates domain requirements (declared in the underlying database schema) and selection predicates (given in the view definition). A node locator 1320 identifies nodes in the tree. The three checks can be performed independently, and therefore, in parallel. After the above checking, the update command is translated by a translator 1322 into update operations against the underlying database.

The work assigned to the database side 1330 consists of three parts: locating tuples for updates 1332, examining constraints 1334, and executing updates 1336. The constraints examined at by checker 1334, called global constraints, are across tuples and relations. Such constraints can be checked only with the knowledge of data in other tuples. Accessing data and checking those constraints can be performed more efficiently at the database side 1330. Local constraints and global constraints are discussed further below in the section entitled “Constraint Satisfaction.”

A subtle decision is when and how to locate the data for updates. One option is to compose the XQuery and XPath predicates with the view definition and transform them into an SQL update against the underlying table, leaving location task entirely to the database system. An alternative scheme is to locate the candidate nodes at the view level and update each of them. Some nodes cannot be located without processing at the view level, such as those including // or * in the XPath expression. The possibility and efficiency of pushing down the processing of location into the relational database is a subject for future research.

Information Collection while Parsing View Definition

The processing of operations at the view side 1310 requires information about the view definition and the relational schema. This information is static throughout the view-definition life, and thus can be collected while parsing the view-definition. For each node in the XML view-definition, the following information is needed:
The underlying table for the data in the node. If the node is derived from an attribute of a relation, the attribute is also recorded.
The node's parent, direct children, and transitive children.
The category of the node. (Note that these three items constitute the information built by the view-relationship graph.)
The updatability of the node according to the DTD.
The local constraints of the node.

The first three items can be obtained from the view query that defines the XML view and the algorithms defined above. Local constraints are collected from the view-query and the underlying relational database schema as discussed in the following section.

Constraint Satisfaction

An important task in maintaining consistency is ensuring constraint satisfaction. There are three sources for constraints: the view definition, the XML DTD and the underlying database schema. On one hand, certain database constraints are non-enforceable at the view level 1310 either because they involve data that do not appear in the view or because the application defining the view lacks the requisite authorization. Meanwhile, certain constraints arising from the DTD, must be enforced at the view level 1310. On the other hand, some constraints from one level can be translated into constraints at the other. In those cases, the choice of level is driven by concerns of efficiency and effectiveness.

Instead of handling the constraints where they are defined (at the sources), the constraints are categorized into two classes based on the number of tuples used to enforce the constraints. If only one tuple is required to enforce the constraint, referred to as a local constraint and check it at the view level; if not, it is referred to as a global constraint and handle it in the relational database. In other words, some database constraints can be checked at the view level, while some view definition and DTD constraints can be translated into database constraints.

View-definition constraints come from selections that are non-correlation predicates. It is noted that correlation and join predicates for the element base view are guaranteed implicitly by the update execution plan. Predicates from selections are enforced on a single tuple and therefore can be enforced at the view. In the DTD, cardinality-related constraints should be transformed and checked at the relational database, as we need data from other tuples to enforce them. Other DTD constraints can be easily enforced at the view level.

There are five types of constraints for relational database:
1. Key constraints: Key constraints are global constraints, as a base table scan or an index lookup needs to be performed to rule out the possibility of duplicate keys.
2. Foreign-key constraints: Constraints included in correlation or join predicates of the view can be enforced by update execution plans. However, if there exists a key—foreign-key relationship between a relation present in the XML view definition and a relation not involved in the view definition, the constraint is categorized as a global constraint that will be handled by the relational database.
3. Domain constraints: The effect of domain constraints is limited to the single tuple, and maybe a single attribute. They can be collected while parsing the view definition and enforced at the view.
4. Not-null constraints: A not-null attribute in a relation that is used in the XML view definition should correspond to an obligatory leaf node. Such constraints are categorized as local constraints. They can be transformed into DTD constraints and enforced at the view during updates.
5. Constraints defined using triggers: These constraints are considered to be global constraints and enforced at the relational database.

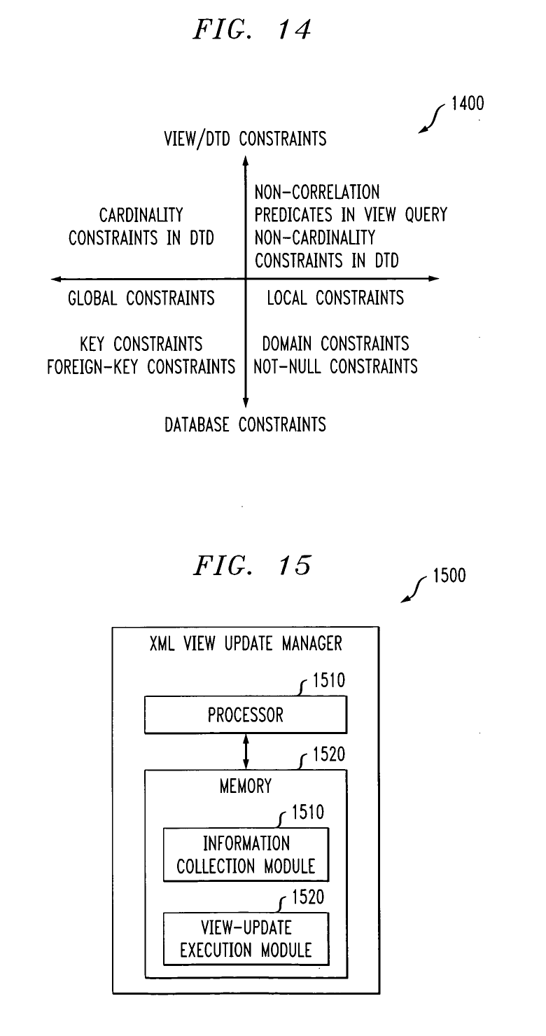

FIG. 14 is a diagram 1400 illustrating the various constraint categories. In summary, local constraints, including view selection predicates, domain constraints, not-null constraints, and non-cardinality DTD constraints should be collected at the time of parsing the view definition and enforced at the view level 13 10. Other constraints are left to the database management system.

Exemplary Implementation

As indicated above, the XML view update manager 1300 was implemented based on the ROLEX system. FIG. 15 illustrates a XML view update manager 1500 in which the present invention may be employed. As shown in FIG. 15, the exemplary XML view update manager 1500 includes a processor 1510 and memory 1520. The architecture 1500 consists of two modules, an information collection module 15 10 and a view-update execution module 1520. The information-collection module 1510 collects the static information described above in the section entitled “Information Collection While Parsing View Definition,” at the time when the view-definition is parsed and sets up the view-relationship graph. The view-relationship graph is then translated into update plans that are persisted in the system and later used at run time.

The view-update execution module 1520 provides the interface for deletion, insertion, movement, and replacement on a given XML Document Object Model (DOM) node at run time. The execution module 1520 interacts with the relational database and the DOM interface to access the underlying data for the XML view.

The two modules 1510, 1520 are connected through the persisted update plans that provide the necessary update translation and propagation information. Experimental results show that the system operates correctly, and the performance is commensurate with direct execution without use of a view.

It is to be understood that the embodiments and variations shown and described herein are merely illustrative of the principles of this invention and that various modifications may be implemented by those skilled in the art without departing from the scope and spirit of the invention.

1. A method for determining if an update to an XML document can be reflected in an underlying relational database, wherein said XML document is comprised of a tree of nodes, said method comprising the steps of:
assigning at least one of a plurality of categories to each of said nodes, wherein said plurality of categories are based on a cardinality relationship indicated by one or more correlation predicates and one or more foreign key constraints in said underlying relational database; and
determining whether said update to said XML document can be reflected in said underlying relational database based on said assigning category.

2. The method of claim 1, wherein said plurality of categories includes overlap island, dependency continent and referenced peninsula categories.

3. The method of claim 1, wherein said plurality of categories includes transitive archipelago and pseudo transitive archipelago categories.

4. The method of claim 1, further comprising the step of determining an update execution strategy based on said assigning category.

5. The method of claim 4, wherein said update is a deletion of a branch dependency continent (DC) node and wherein said update execution strategy comprises the steps of:
deleting the corresponding tuple in an element base view; and
propagating the deletion recursively to all branch dependency continent-children of the deleted node.

6. The method of claim 4, wherein said update is an insertion of a branch dependency continent node that is permitted only if overlap island-descendants of the inserted node, as given in the insertion, include exactly those descendant nodes that can be derived from existing tuples in the database that satisfy the correlation predicates and each branch node in the inserted subtree has a leaf child corresponding to the key of the element base view; and wherein said update execution strategy comprises the steps of:
inserting said corresponding tuple, with the foreign-key values equal to the key values of its direct parent, into the element base view;
propagating the insertion recursively to all branch dependency continent-children of the inserted node; and
propagating the insertion to its branch referenced peninsula-descendants that contain new values.

7. The method of claim 4, wherein said update is a movement of a branch dependency continent node that is permitted only when a foreign key in the node to be moved does not itself appear in the view as a leaf node and wherein said update execution strategy comprises the step of setting foreign-key values in an element base view of the DC-node to the key values of its new direct parent:

8. The method of claim 4, wherein said update is a deletion of a leaf DC-node that is permitted only when the node does not correspond to a foreign key appearing in correlation predicates and wherein said update execution strategy comprises the step of setting a corresponding attribute in the element base view to NULL.

9. The method of claim 4, wherein said update is an insertion of a leaf DC-node that is permitted only when the leaf node does not correspond to a foreign key appearing in correlation predicates and wherein said update execution strategy comprises the step of assigning a value to the corresponding attribute in the element base view.

10. The method of claim 4, wherein said update is a deletion of a referenced peninsula (RP) root-node that is permitted only when a foreign key of the parent node does not appear in the view as a leaf node and wherein said update execution strategy comprises the step of setting the foreign-key values in the element base view of its direct parent to NULL.

11. The method of claim 4, wherein said update is an insertion of an RP-root-node that is permitted only when a foreign key of the parent node does not appear in the view as a leaf node; overlap island (0l)-descendants of the inserted node, as given in the insertion, include exactly those descendant nodes that can be derived from existing tuples in the database that satisfy the correlation predicate(s); and each branch node in the inserted subtree has a leaf child corresponding to the key of the element base view; and wherein said update execution strategy comprises the steps of setting the foreign-key values in the element base view of its direct parent to the key values in its element base view; inserting the corresponding tuple into the element base view if the inserted node contains new values; and propagating the insertion to its branch RP-descendents that contain new values.

12. A system for determining if an update to an XML document can be reflected in an underlying relational database, wherein said XML document is comprised of a tree of nodes, comprising:
a memory; and
at least one processor, coupled to the memory, operative to:
assign at least one of a plurality of categories to each of said nodes,
wherein said plurality of categories are based on a cardinality relationship indicated by one or more correlation predicates and one or more foreign key constraints in said underlying relational database; and
determine whether said update to said XML document can be reflected in said underlying relational database based on said assigning category.

13. The system of claim 12, wherein said plurality of categories includes overlap island, dependency continent and referenced peninsula categories.

14. The system of claim 12, wherein said plurality of categories includes transitive archipelago and pseudo transitive archipelago categories.

15. The system of claim 12, wherein said processor is further configured to determine an update execution strategy based on said assigning category.

16. An article of manufacture for determining if an update to an XML document can be reflected in an underlying relational database, wherein said XML document is comprised of a tree of nodes, comprising a machine readable medium containing one or more programs which when executed implement the steps of:
assigning at least one of a plurality of categories to each of said nodes, wherein said plurality of categories are based on a cardinality relationship indicated by one or more correlation predicates and one or more foreign key constraints in said underlying relational database; and
determining whether said update to said XML document can be reflected in said underlying relational database based on said assigning category.

17. The article of manufacture of claim 16, wherein said plurality of categories includes overlap island, dependency continent and referenced peninsula categories.

18. The article of manufacture of claim 16, wherein said plurality of categories includes transitive archipelago and pseudo transitive archipelago categories.

19. The article of manufacture of claim 16, wherein said processor is further configured to determine an update execution strategy based on said assigning category.
